(19) United States
(12) Patent Application Publication
(10) Pub. No.: US 2008/0272154 A1
(43) Pub. Date: Nov. 6, 2008

(54) Method And Assembly For Dispensing A Product From A Form-Retaining Container

(76) Inventors: Wilhelmus Johannes Joseph Maas, Someren (NL); Petrus Lambertus Wilhelmus Hurkmans, Someren (NL); Dominicus Jan Wijk, Helmond (NL)

Correspondence Address: HARNESS, DICKEY & PIERCE, P.L.C., P.O.BOX 8910, RESTON, VA, 20195, US

(21) Appl. No.: 11/992,409

(22) PCT Filed: Sep. 25, 2006
(86) PCT No.: PCT/EP2006/009268

§ 371 Date: Jun. 26, 2008

(30) Foreign Application Priority Data
Sep. 23, 2005 (NL) 1030018
May 28, 2006 (EP) 06010958.4

(51) Int. Cl. B67D 5/42

(52) U.S. Cl. 222/386.5

(57) ABSTRACT

An embodiment of the present invention relates to a method for dispensing one or more products to an assembly for carrying out this method, including a form-retaining container for receiving the product(s), the container having an outflow opening, and devices for introducing into the container a medium for displacing the product(s). The displacing medium introduction devices are arranged for introducing the displacing medium into the container such that it exerts on the product(s) substantially only a force directed towards the outflow opening. The displacing medium introduction devices may include a chamber that is separated from the part of the container containing the product(s) via a flexible diaphragm. The dispensing assembly may further include a dispensing adapter connected to the container around the outflow opening and supporting a movable closure member.

The present invention relates to a method for dispensing at least one product from a form-retaining container through an outflow opening by introducing into the container a medium for displacing the at least one product to be dispensed. Such a method is known.

It is known to dispense products, in particular products having a low viscosity, like liquids, but also more viscous or “pasty” products like sauces and even ice cream by using so-called “bag-in-box” or “bag-in-bottle” systems. In such systems, the product to be dispensed is packed in a—usually flexible—inner container or bag, which is arranged inside a—usually form-retaining—outer container, the box or bottle. The bag is provided with an outflow opening having a controllable valve or closure member protruding from an opening that is formed in the box or bottle.

For dispensing products having a low viscosity, like liquids, it is usually sufficient to position the system such that the outflow opening is near the lowermost point, and open the valve in the outflow opening, after which the product will flow from the outflow opening under the influence of gravity. At the same time ambient air flows into the container to take up the space freed by the dispensed product.

When the product to be dispensed has a higher viscosity, however, for instance in the case of a relatively thick sauce or even ice cream, gravity pull is insufficient and the product will have to be pumped from the container. To this end use can be made of a pump that is connected to the bag, but it is also possible to force the product from the bag by pumping another medium into the space between the container and the bag. This medium will then exert a pressure on the bag and thus displace the product from the container.

The known bag-in-box or bag-in-bottle systems have the drawback that it is not always possible to completely dispense the product contained therein. This applies in particular when they are filled with highly viscous products. This problem is caused by the inertia of the highly viscous product, which results in voids in the remaining product, whenever part of the product is dispensed from the container. Since the product moves too slowly to fill these voids, the bag—under the influence of the displacing medium—will form bulges filling them. These bulges narrow or even completely obstruct the path that the remaining product has to follow to reach the outflow opening, thus trapping part of the product in the container. Eventually bulging parts of the bag may even protrude into the outflow opening, thus blocking all further product flow. The amount of product remaining in the container represents a loss to the consumer.

In an attempt to solve this problem, use is often made of a so-called “anti-collapse” member, which may be a tube or a shaft carrying a cross or small plates, extending from the outflow opening. This anti-collapse member protrudes relatively deep into the bag to prevent it from collapsing as long as the product has not been completely dispensed from the container. However, this anti-collapse member in itself constitutes an obstacle for the product moving towards the outflow opening, in particular for highly viscous products, which will adhere to the anti-collapse member and which will hardly flow through a tube. Moreover, when the temperature of the product to be dispensed is below the freezing point, as is the case with ice cream, this will adhere even more strongly to the anti-collapse member.

The invention has for its object to provide an improved method for dispensing one or more products from a form-retaining container, by which a smooth outflow of product is guaranteed under virtually all circumstances and which prevents any residual product from becoming trapped in the bag. In accordance with the invention, this is accomplished in a method of the type described above, in that the displacing medium is introduced into the container such that it exerts on the at least one product substantially only a force directed towards the outflow opening.

By letting the displacing medium exert only a force that is directed towards the outflow opening, this medium acts as a kind of piston, uniformly pushing the product forward over a substantially straight front. Since the product moves uniformly towards the outflow opening over substantially the entire cross-section of the container, no voids are formed in the product. Consequently, the risk of parts of the product being trapped is greatly reduced, and the container may be completely emptied.

In order to achieve the pressure distribution required to exert a force in the direction of the outflow opening, the displacing medium is preferably introduced into the container substantially at the side thereof opposite the outflow opening.

In a preferred embodiment of this dispensing method, the displacing medium is introduced into a chamber that is separated from the part of the container containing the at least one product by means of at least one flexible diaphragm. In this way contact between the product and the displacing medium is avoided, and there is no risk of contamination of the product.

The container may contain a plurality of products, which may be simultaneously dispensed by introduction into the container of the displacing medium. In this way two or more products may be mixed when they leave the container.

When a pressurized gas, in particular ambient air is used as displacing medium, the method may easily be practiced by providing either a pressurized gas canister or a pump.

Alternatively, a liquid may be used as displacing medium, in particular water, which is usually available at mains pressure.

In order to generate sufficient force for expelling the product from the container without having to resort to aerosols, the displacing medium is preferably introduced at a pressure of 0.1 to 5 bar above ambient pressure. In a further preferred variant of the dispensing method the displacing medium is introduced at a pressure of 0.5 to 3 bar, in particular 0.75 to 2 bar above ambient pressure.

For effectively controlling the amount of product that is dispensed, it is preferable to have a movable closure member arranged over the outflow opening, said closure member being moved from a closed position to an open position when the displacing medium is introduced into the container.

The invention also relates to a dispensing assembly with which the above described method may be performed.

A known assembly for dispensing at least one product comprises a form-retaining container for receiving the at least one product, said container having at least one outflow opening, and means for introducing into the container a medium for displacing the at least one product to be dispensed.

The dispensing assembly of the present invention is distinguished from this known assembly in that the displacing medium introduction means are arranged for introducing the displacing medium into the container such that it exerts on the at least one product substantially only a force directed towards the outflow opening.

In order to achieve the required pressure distribution, the displacing medium introduction means are preferably operative at the side of the container opposite the outflow opening.

In a preferred embodiment of the dispensing assembly, the displacing medium introduction means include a chamber that is separated from the part of the container containing the at least one product by means of at least one flexible diaphragm, so as to avoid possible contamination of the product by the displacing medium.

In order to maximize the capacity of the container and yet guarantee that it may be completely emptied, the at least one flexible diaphragm is preferably deformable and/or displaceable between a first extreme position in which it lies substantially along the side of the container opposite the outflow opening and a second extreme position in which it lies substantially along the side of the container in which the outflow opening is arranged.

In a first embodiment of the dispensing assembly, the at least one flexible diaphragm has a peripheral edge attached to a sidewall of the container. Thus the diaphragm extends over the entire cross-section of the container. Because in its first extreme position, when the container is completely filled with product, the diaphragm extends from the attachment point along the sidewall to the side opposite the outflow opening, the product is kept free of the sidewall over a substantial part of the height of the container, thus reducing friction and facilitating movement of the product towards the outflow opening.

In one variant of this embodiment, the container comprises two parts that are mutually connected by means of mating flanges, and the peripheral edge of the at least one flexible diaphragm is sealingly clamped between the mating flanges. In this way the container and diaphragm may be easily assembled from a limited number of parts that are moreover easy to manufacture.

Alternatively, the container may comprise at least an outer layer and an inner layer, and the at least one flexible diaphragm may be integrally molded with said inner layer of the container. By manufacturing the container and diaphragm as a single piece, the need for any assembling operations is obviated.

In a second embodiment of the dispensing assembly, the at least one flexible diaphragm forms part of a separate bag arranged in the container and defining the chamber for the dispensing medium and/or the part of the container containing the at least one product. In this way the invention may be practiced using a standard container, manufactured by conventional techniques.

In one variant of this embodiment the bag may substantially fill the interior of the container and may include at least one compartment forming the container part containing the product to be dispensed and another compartment forming the chamber for the displacing medium, and the compartments may be separated by the flexible diaphragm. Both the product and the displacing medium are thus isolated from the container, which may then be made from any suitable material.

The bag may have a plurality of compartments for a variety of products to be dispensed simultaneously.

In another variant of this embodiment, the bag may be arranged along the side of the container opposite the outflow opening and may form the chamber for the displacing medium, in which case the flexible diaphragm may be formed by the side of the bag facing the outflow opening. After arranging the bag at the bottom, the container may then simply be filled with the product to be dispensed.

In that case, the bag preferably includes stabilizing means arranged along its circumference. After the bag is introduced into the container, these stabilizing means will ensure that it fits tightly against the container sidewall.

However, it is also conceivable that the bag is arranged along the side of the container in which the outflow opening is defined and forms the container part containing the product, in which case the flexible diaphragm is formed by the side of the bag opposite the outflow opening.

These two variants may advantageously be combined, resulting in a dispensing assembly in which the product to be dispensed is packed in a bag which is arranged between the outflow opening and the bag that will be filled with the displacing medium.

In order to allow the displacing medium to be introduced into the container, the displacing medium introduction means preferably include a supply port accessible from the outside of the container and connected to the chamber.

A valve may be arranged between the chamber and the supply port to prevent the displacing medium, which will be at a higher than ambient pressure, from flowing out of the chamber.

In a preferred embodiment of the dispensing assembly the supply port is arranged within or adjacent the outflow opening and is connected to the chamber by a supply line arranged inside the container. In this way only a single opening needs to be formed in the container and all connections may be made at a central location.

The displacing medium introduction means preferably include a source of displacing medium. This source of displacing medium may be a pump for pressurizing a gas, in particular ambient air, or it may be a liquid supply conduit, in particular a water pipe.

In a preferred embodiment of the dispensing assembly the displacing medium introduction means are arranged to introduce the displacing medium at a pressure of 0.1 to 5 bar above ambient pressure. More preferably, the displacing medium introduction means are arranged to introduce the displacing medium at a pressure of 0.5 to 3 bar, in particular 0.75 to 2 bar above ambient pressure.

A lightweight yet sturdy, low-cost dispensing assembly may be obtained when the container is made from a plastics material, in particular stretched PET or a polyolefin.

Preferably, the at least one flexible diaphragm is made from a plastics material as well, in particular a polyamide or a polyolefin like polyethylene. In order to facilitate recycling of the dispensing assembly after use, the plastics material from which the diaphragm is made may be identical or at least related to the plastics material of the container. Another criterion when selecting suitable (plastics) materials for the container and the flexible diaphragm is that they should retain favorable properties at the low temperatures (in the order of −15° to −20° C.) encountered when the product to be dispensed is ice cream.

For controlling the flow of product out of the container, the dispensing assembly preferably includes a movable closure member arranged over the outflow opening.

In order to allow the dispensing assembly to be used in conjunction with a dispensing mechanism, the movable closure member may form part of a dispensing adapter connected to the container around the outflow opening. This dispensing adapter may then be coupled to the dispensing mechanism.

The dispensing adapter may advantageously include an outflow conduit connected to the outflow opening of the container, in which case the closure member is arranged for closing off the outflow conduit.

In order to obtain an easily movable closure member having good sealing characteristics, the outflow conduit preferably has a curved outer edge, while the closure member has a corresponding curvature and is pivotable about an axis.

When the closure member is arranged on the inside of the dispensing adapter, it may be easily moved between its closed and open positions if it is connected to a control member on the outside of the dispensing adapter through the pivot axis.

In that case, excellent sealing is obtained when the closure member is more flexible than the surrounding structure of the dispensing adapter, so that it may be slightly deformed by the pressure exerted thereon by the product, thus sealing the outflow conduit.

When the control member extends outside a profiled collar of the dispensing adapter, the dispensing assembly may be tightly fitted in a dispensing mechanism by its collar, while still leaving the control member free to move.

The dispensing adapter preferably further includes a connector for interconnecting the source of displacing medium and the supply port, so that the dispensing assembly may be, fully functionally coupled to the dispensing mechanism through the adapter only.

Finally, the invention relates to a dispensing adapter for use in the dispensing assembly of the type described above.

The invention is now elucidated by means of a number of non-limiting exemplary embodiments thereof, with reference being made to the accompanying drawings, in which:

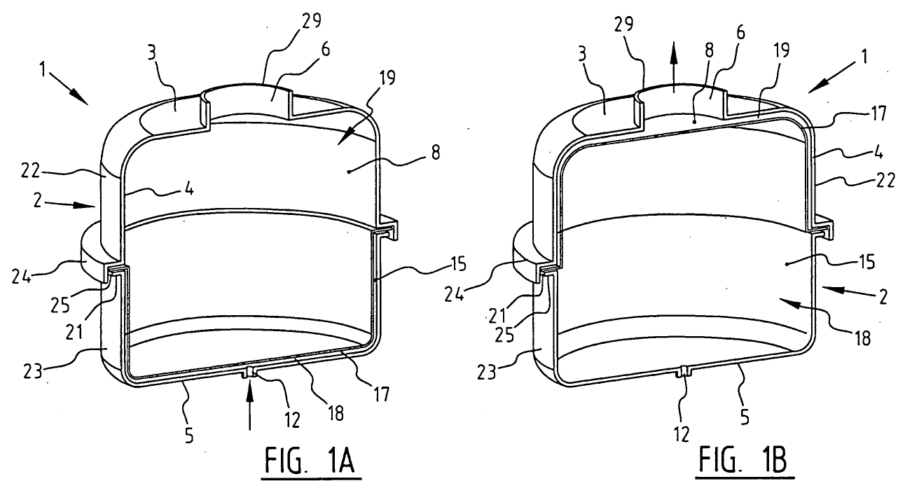

FIGS. 1A and 1B show perspective longitudinal sectional views of a first embodiment of the dispensing assembly of the present invention, including a diaphragm that is clamped between two parts of the container, in a first extreme position when the container is substantially filled with product to be dispensed and a second extreme position, in which substantially all of the product has been expelled from the container, respectively;

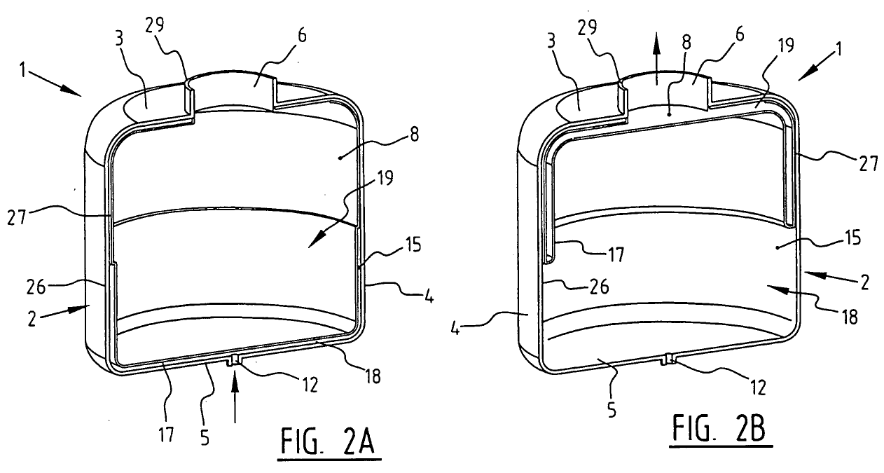

FIGS. 2A and 2B are views corresponding with those of FIGS. 1A and 1B of a variant of this embodiment, in which the diaphragm forms an integral part of an inner layer of a multi-layered container;

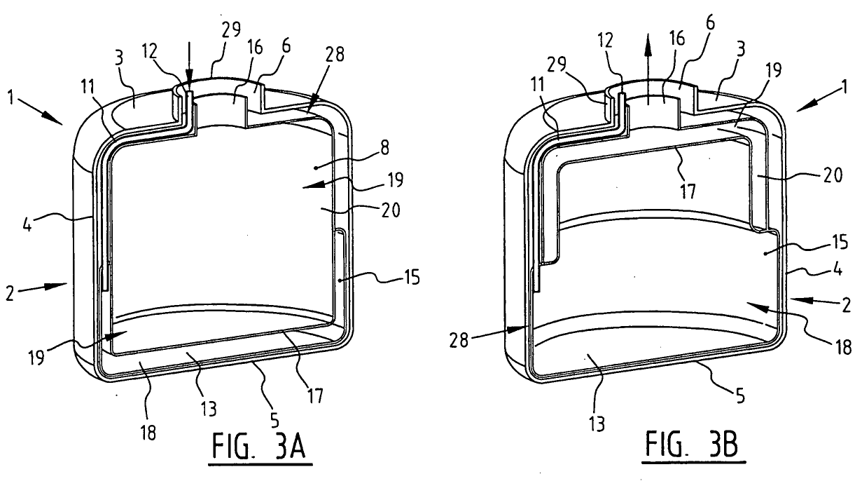

FIGS. 3A and 3B show views corresponding with those of FIGS. 1 and 2 of a second embodiment of the dispensing assembly, in which the diaphragm forms part of a separate bag arranged inside the container, the bag having a compartment for the product to be dispensed and one for the displacing medium;

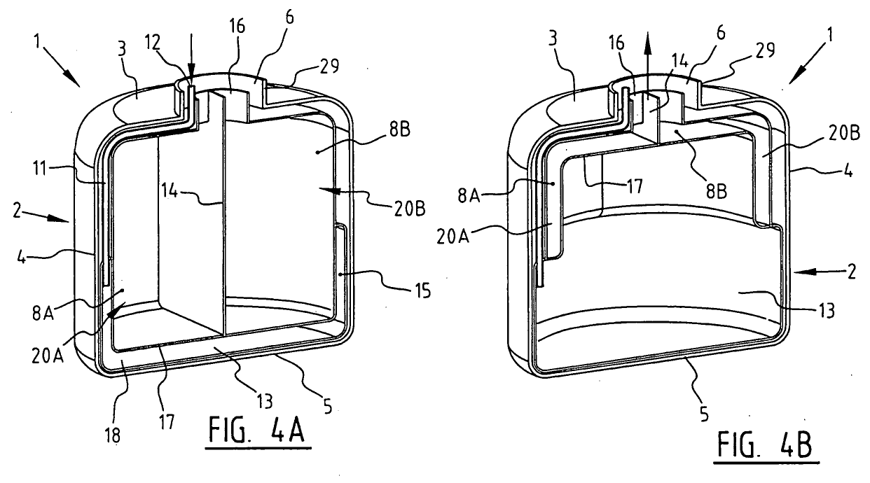

FIGS. 4A and 4B are views corresponding with those of FIGS. 1 through 3 of a variant of this embodiment, in which there are two side-by-side compartments for two different products that are to be dispensed simultaneously;

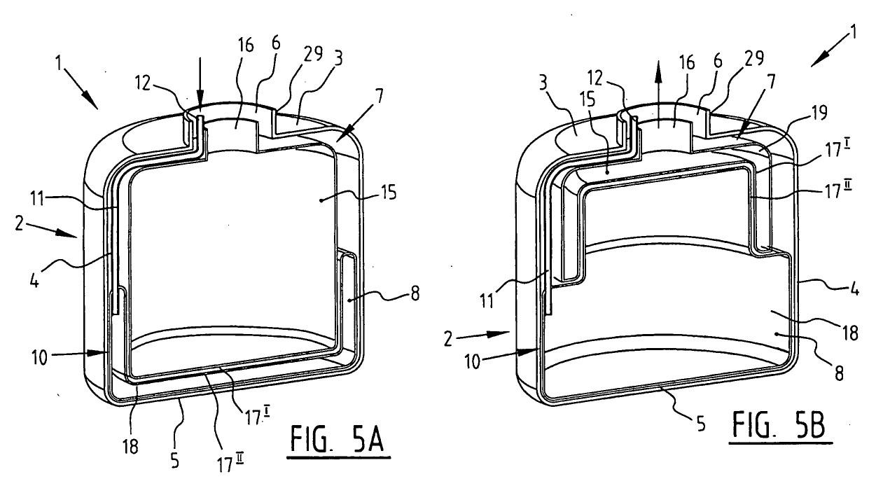

FIGS. 5A and 5B are views corresponding with those of the previous Figures of another variant of this embodiment, in which there are two separate bags for the product and the displacing medium, respectively;

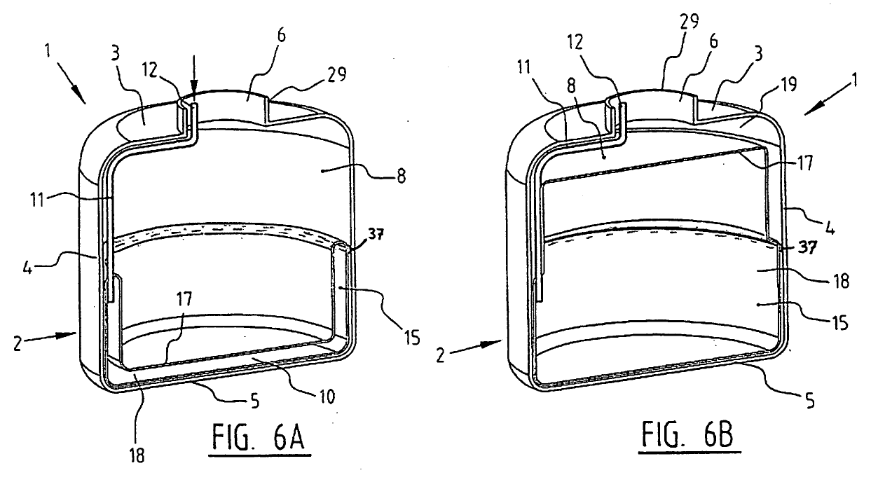

FIGS. 6A and 6B are views corresponding with those of the previous Figures of yet another variant of this embodiment, in which there is only a single bag for the displacing medium, the product being packed directly in the container;

FIG. 7 is a side view of the dispensing assembly ready for use;

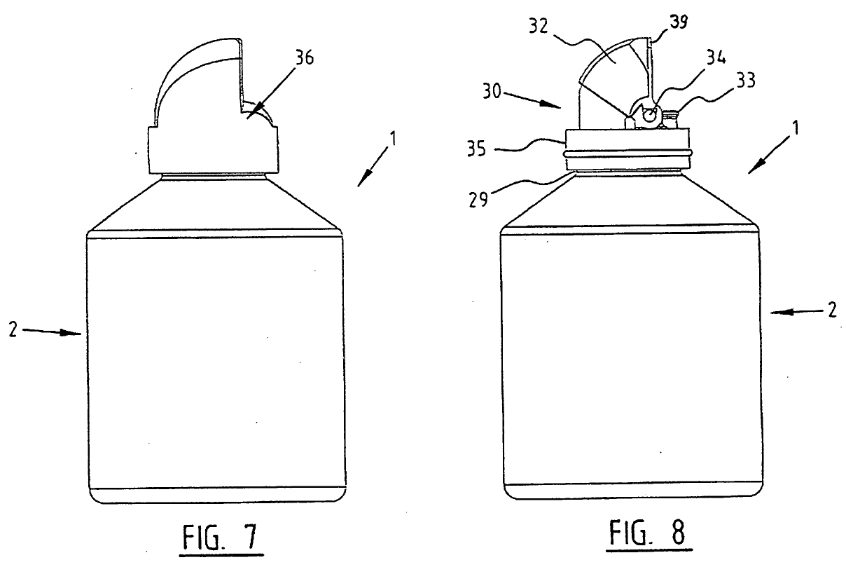

FIG. 8 is a side view of the assembly of FIG. 7 in a transport and storage state, the outflow opening being covered by a protective cap;

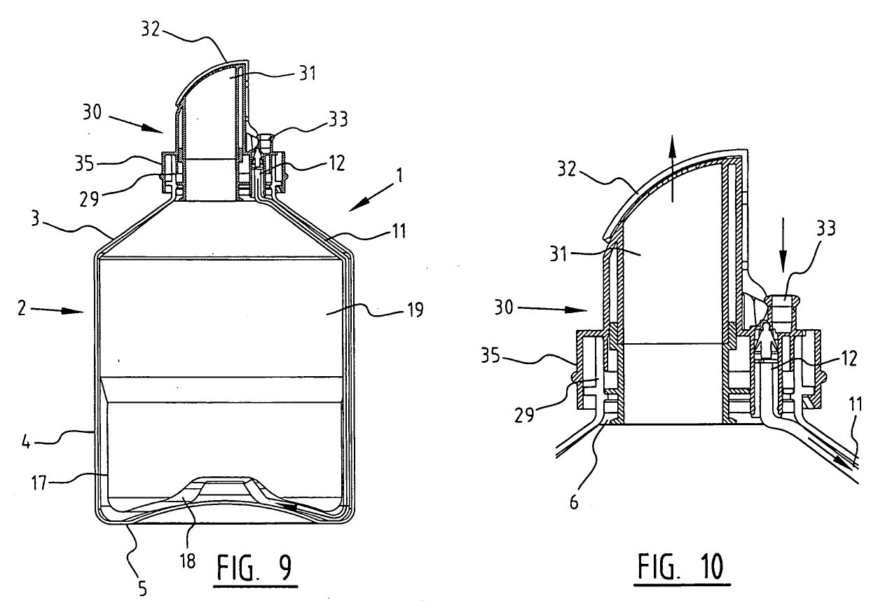

FIG. 9 is a longitudinal sectional view of the dispensing assembly of FIGS. 8 and 9;

FIG. 10 is an enlarged scale detail view of the outflow opening and pressurized air supply port of the dispensing assembly shown in FIG. 9;

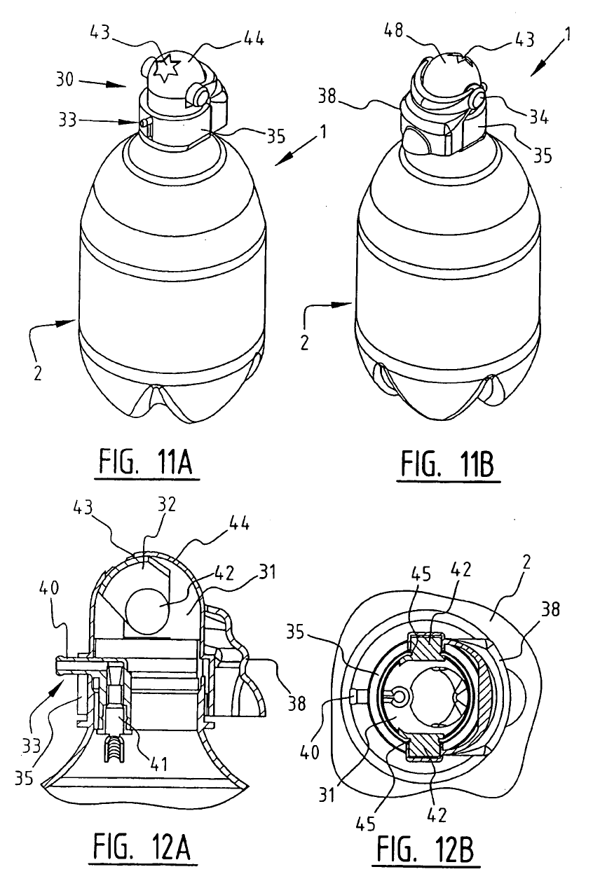

FIGS. 11A and 11B are front and rear perspective views, respectively, of an alternative embodiment of the dispensing assembly;

FIG. 12A is a longitudinal sectional view of the top of the container and the dispensing adapter of the assembly of FIG. 11; and

FIG. 12B is a cross-sectional view along the line B-B in FIG. 12A.

An assembly 1 for dispensing at least one product 8 comprises a form-retaining container 2 for receiving the product 8 to be dispensed. The container 2, which may be made from a plastics material like e.g. stretched PET or a polyolefin, has a top wall 3, a cylindrical sidewall 4 and a bottom wall 5. An outflow opening 6 for dispensing the product 8 is defined in the top wall 3.

The dispensing assembly 11 further includes means 9 for introducing into the container 2 a medium 15 for displacing the product 8 to be dispensed. In accordance with the present invention, these displacing medium introduction means 9 are arranged for introducing the displacing medium 15 into the container 2 such that the force which it exerts on the product 8 is directed substantially exclusively towards the outflow opening 6. To this end, the displacing medium 15 is introduced into the container 2 near the bottom 5, opposite the outflow opening 6. The displacing medium 15 is introduced into a chamber 18 that is separated from the part 19 of the container 2 where the product 8 is held by a flexible diaphragm 17. This flexible diaphragm 17 may also advantageously be made from a plastics material, like e.g. a polyamide or a polyolefin, in particular polyethylene.

The displacing medium introduction means 9 further include a supply port 12 that is accessible from the outside of the container 2 and that is connected to the chamber 18. The displacing medium introduction means 9 also include a source of displacing medium 15 (not shown here), which may be connected to the supply port 12. This source of displacing medium 15 may be a pump or compressor for pressurizing a gas, for instance ambient air, but may also include a canister filled with pressurized gas. Alternatively, the source of displacing medium 15 may be a liquid supply conduit, in particular a water pipe, which is easily available at most locations. A valve (not shown here) may be arranged in the supply port 12 or between the chamber 18 and the supply port 12 to prevent the displacing medium 15 from flowing out of the chamber 18.

In order to generate sufficient force to properly expel the product 8 from the container 2, without risking deformation of the container 2 or excessive pressures, the source of displacing medium 15 may be adapted to supply the displacing medium at a pressure that is 0.1 to 5 bar above the ambient pressure. Preferably, even lower pressures are used, for instance within a range of 0.5 to 3 bar above ambient, and most preferably 0.75 to 2 bar above ambient pressure. These are values that may easily be obtained using a hand pump.

In the first embodiment the diaphragm 17 has a peripheral edge 21 that is attached to the sidewall 4 of the container, approximately halfway between the top wall 3 and the bottom 5. In a first extreme position—when the container 2 is completely filled with product 8—the diaphragm 17 extends from the point of attachment along the sidewall 4 to the bottom 5 of the container 2, more or less forming a bucket opposite the outflow opening 6 (FIG. 1A). In a second extreme position—when the container 2 has been emptied—the diaphragm 17 extends from the attachment point along the sidewall 4 to the top wall 3 of the container 2 and runs substantially along the outflow opening 6 (FIG. 1B).

In the illustrated variant the container 2 comprises an upper part 22 having a lower flange 24 and a lower part 23 having an upper flange 25. These two parts 22, 23 are mutually connected by means of the mating flanges 24, 25, which may be bonded or welded together. At the same time the peripheral edge 21 of the flexible diaphragm 17 is attached to the sidewall 4 by sealingly clamping it between the mating flanges 24, 25 or bonding or welding it together with these flanges.

Another variant of the embodiment having the diaphragm 17 attached to the sidewall 4 is shown in FIGS. 2A and 2B. Here the container 2 comprises at least an outer layer 26 and an inner layer 27, which may or may not be made from the same material. These layers 26, 27 are co-molded into a preform and subsequently blow-molded into the final container shape. When co-molding the outer and inner layers 26, 27, a layer of a non-adhering material is inserted between these layers in the lower part of the mold, which will shape the bottom 5 and lower part of the sidewall 4. The presence of this non-adhering layer results in the outer and inner layers 26, 27 lying loose, thus forming a chamber 18 in the lower part of the container 2. The loose part of the inner layer 27 then forms the flexible diaphragm 17 separating this chamber 18 from the remaining part 19 of the container 2.

In both variants of this first embodiment the supply port 12 is shown to be arranged in the bottom 5 of the container, opposite the outflow opening 6.

In a second embodiment the diaphragm 17 is not a separate part attached inside the container 2, but forms part of a bag. In the variant shown in FIGS. 3A and 3B the bag 28 is shaped and dimensioned to substantially fill the interior of the container 2. The bag 28 includes a first compartment 20 arranged nearest the outflow opening and forming the container part 19 in which the product 8 is packaged. This first compartment 20 includes an outflow opening 16 of its own, which protrudes into the outflow opening 6 of the container 2. The bag 28 further includes a second compartment 13 forming the chamber 18 for the displacing medium 15. The first and second compartments 13, 20 are separated by the flexible diaphragm 17.

In this embodiment the supply port 12 is arranged within the outflow opening 6. In this way only a single opening needs to be formed in the container 2. The supply port 12 is connected to the chamber 18 defined by the second compartment 13 of the bag 28 by a supply line 11. This supply line 11 is shown to run substantially parallel to the top wall 3 and sidewall 4 of the container 2. It could also be incorporated into the container walls, for instance when the container 2 has a multi-layered structure.

Another variant of this embodiment is suitable for simultaneously dispensing two products 8A and 8B, which may be mixed outside the container 2 (FIGS. 4A and 4B). To this end the first compartment is divided into two sub-compartments 20A and 20B by means of a divider wall 14. Although in the illustrated variant the sub-compartments 20A, 20B are identical, this is not necessary. In fact, the ratio between the cross-sections and volumes of the sub-compartments should be chosen so as to correspond with the required mixing ratio of the two products 8A and 8B.

Instead of a single bag 28 divided into compartments 13, 20 by the flexible diaphragm 17, the dispensing assembly may also include two separate bags 7, 10 defining the product containing part 19 and the displacing medium chamber 18, respectively (FIGS. 5A and 5B). These bags 7, 10 may or may not be mutually connected. The lower bag 10 defining the chamber 18 is configured and dimensioned such that it substantially surrounds the lower half of the upper bag 7 when this is filled with the product 8 and substantially fills the entire container 2 when the upper bag 7 is emptied.

In yet another variant of this second embodiment of the dispensing assembly the upper bag 7 is eliminated and the product is introduced directly into the part 19 of the container 2 above the lower bag 10 (FIGS. 6A and 6B). In order to prevent the product from finding its way between the bag 10 and the sidewall 4 when the container 2 is being filled, the bag 10 is provided with stabilizing means 37 arranged along its circumference. These stabilizing means 37, which are resiliently deformable, will force the bag 10 against the sidewall 4 after it has been introduced into the container 2 through the opening 6. in the illustrated embodiment the stabilizing means 37 are formed by a peripheral channel welded to the bag 10 and filled with a medium like pressurized air or water. Alternatively, the stabilizing means could include a ring or collar from a relatively stiffer material—although the ring or collar should still be resiliently deformable to allow it to be introduced through the opening 6. Although this variant is simpler than that of FIGS. 4 and 5, it does result in a somewhat higher friction between the product 8 and the sidewall 4. Therefore, this variant is only suitable for products which are not too viscous and do not adhere very strongly to the material of the container 2.

In all shown embodiments the outflow opening 6 is surrounded by a neck 29. This neck 29 may be provided with connecting means—for instance threading, bayonet provisions or snap provisions—for mounting a dispensing adapter 30 onto the container 2 (FIGS. 9 and 10). This dispensing adapter 30 includes an outflow conduit 31 closed off by a controllable closure member 32 and a connector 33 for connecting the source of displacing medium 15 to the supply port 12. In the shown embodiment the outflow conduit 31 has a curved outer edge and the closure member 32 is pivotable about an axis 34 (FIG. 7).

Using this dispensing adapter 30, the product 8 is dispensed from the container 2 by first introducing the displacing medium 15 into the chamber 18, for instance by operating a pump or compressor for pressurizing ambient air or by opening a water faucet, and then moving the closure member 32 to a position in which the outflow conduit 31 is opened. Whenever the outflow of the product 8 decreases, the pressure in the chamber 18 may be increased by introducing additional displacing medium 15. When a desired amount of the product 8 has been dispensed, the closure member 32 may be returned to its closed position.

The dispensing adapter 30 is designed to allow the dispensing assembly 1 to be used in combination with a dispensing mechanism as disclosed in the co-pending patent application entitled “Apparatus for dispensing a product from a form-retaining container”. To this end it includes a profiled collar 35 that is accommodated in a correspondingly profiled opening in the dispensing mechanism. This profiled collar also serves to hold a protective cover 36 when the dispensing assembly is not in use (FIG. 8), in particular during transport and storage of the dispensing assembly. Moreover, the closure member 32 is provided with a protruding edge 39 for engagement by a control member of the mechanism.

In an alternative embodiment of the dispensing assembly (FIG. 11) the outside edge of the outflow conduit 31 of the dispensing adapter 30 is curved in two directions, i.e. domed. The closure member 32 is arranged at the inside of the dome 44 and is connected to a control member 38 at the outside of the dome 44 through its pivot axis 34. To this end the closure member 32 is attached to shafts 42 which are rotatably snapped into openings 45 in the dome 44 and which are attached to the control member 38. By pivoting the control member 38 approximately 90 degrees about the axis 34, the closure member 32 is moved between its closed position shown in the drawings and its open position.

The control member 38 extends outside the circular collar 35 of the dispensing adapter 30, which may be received in a semi-circular recess in the dispensing mechanism. In this way a secure connection between the dispensing assembly 1 and the dispensing mechanism is formed, while the control member 38 is left free to move.

In this embodiment, the closure member 32 is more flexible than the surrounding structure of the dome 44, e.g. because it is made from a softer material. This ensures that the closure member 32 is slightly deformed by the pressure exerted thereon by the product in the container 2. This slight deformation leads to excellent sealing of the closure member 32 against the edges of the opening 43 at the end of the outflow conduit 31.

The connector 33 is angled over 90 degrees and has a first leg 40 extending from the collar 35 for connection to the source of dispensing medium 15, which may form part of the dispensing mechanism, and a second leg 41 extending into the container 2 and adapted for accommodating the supply port 12 of the supply line 11 leading to the chamber 18.

Although the invention has been illustrated by referring to a number of exemplary embodiments thereof, it will be clear that it is by no means limited to the shown embodiments. For instance the various ways of forming a chamber for the displacing medium may be combined with either of the two shown dispensing adapters. The various embodiments of the container including the chamber may also be used in combination with other mechanisms for closing and opening the outflow opening. The invention may be adapted and modified in various ways within the scope of the appended claims.

1. A method for dispensing at least one product from a form-retaining container through an outflow opening by introducing into the container a medium for displacing the at least one product to be dispensed,
wherein the displacing medium is introduced into the container such that it exerts on the at least one product substantially only a force directed towards the outflow opening, and
wherein the displacing medium is introduced into a chamber that is separated from the part of the container containing the at least one product by means of at least one flexible diaphragm,
wherein the container the container comprises at least an outer layer and an inner layer, the at least one flexible diaphragm being integrally molded with said inner layer of the container.

2. The method of claim 1, wherein the displacing medium is introduced into the container substantially at the side thereof opposite the outflow opening.

3. The method of claim 1, wherein the container contains a plurality of products, which are simultaneously dispensed by introduction into the container of the displacing medium.

4. The method of claim 1, wherein a pressurized gas, in particular ambient air is used as displacing medium.

5. The method of claim 1, wherein a liquid, in particular water, is used as displacing medium.

6. The method of claim 1, wherein the displacing medium is introduced at a pressure of 0.1 to 5 bar above ambient pressure.

7. The method of claim 1, wherein the displacing medium is introduced at a pressure of 0.5 to 3 bar, in particular 0.75 to 2 bar above ambient pressure.

8. The method of claim 1, wherein a movable closure member is arranged over the outflow opening said closure member being moved from a closed position to an open position when the displacing medium is introduced into the container.

9. As assembly for dispensing at least one product, comprising:
a form-retaining container for receiving the at least one product, said container having at least one outflow opening, and
means for introducing into the container a medium for displacing the at least one product to be dispensed,
wherein the displacing medium introduction means are arranged for introducing the displacing medium into the container such that it exerts on the at least one product substantially only a force directed towards the outflow opening, and
wherein the displacing medium introduction means include a chamber that is separated from the part of the container containing the at least one product by means of at least one flexible diaphragm that has a peripheral edge attached to a sidewall of the container,
wherein the container comprises at least an outer layer and an inner layer, the at least one flexible diaphragm being integrally molded with said inner layer of the container.

10. The dispensing assembly of claim 9, wherein the container and diaphragm are formed by co-molding the outer layer and inner layer into a preform and subsequently blow-molding the layers into the final container shape.

11. The dispensing assembly of claim 9, wherein the displacing medium introduction means are operative at the side of the container opposite the outflow opening.

12. The dispensing assembly of claim 9, wherein the at least one flexible diaphragm is deformable and/or displaceable between a first extreme position in which it lies substantially along the side of the container opposite the outflow opening and a second extreme position in which it lies substantially along the side of the container in which the outflow opening is arranged.

13. The dispensing assembly of claim 9, wherein the displacing medium introduction means include a supply port accessible from the outside of the container and connected to the chamber.

14. The dispensing assembly of claim 13, characterized by a valve arranged between the chamber and the supply port.

15. The dispensing assembly of claim 13, wherein the supply port is arranged within or adjacent the outflow opening and is connected to the chamber by a supply line arranged inside the container.

16. The dispensing assembly of claim 9, wherein the displacing medium introduction means include a source of displacing medium.

17. The dispensing assembly of claim 16, wherein the source of displacing medium is a pump for pressurizing a gas, in particular ambient air.

18. The dispensing assembly of claim 16, wherein the source of displacing medium is a liquid supply conduit, in particular a water pipe.

19. The dispensing assembly of claim 9, wherein the displacing medium introduction means are arranged to introduce the displacing medium at a pressure of 0.1 to 5 bar above ambient pressure.

20. The dispensing assembly of claim 19, wherein the displacing medium introduction means are arranged to introduce the displacing medium at a pressure of 0.5 to 3 bar, in particular 0.75 to 2 bar above ambient pressure.

21. The dispensing assembly of claim 9, wherein the container is made from a plastics material, in particular stretched PET or a polyolefin.

22. The dispensing assembly of claim 9, wherein the at least one flexible diaphragm is made from a plastics material, in particular a polyamide or a polyolefin.

23. The dispensing assembly of claim 9, characterized by a movable closure member arranged over the outflow opening.

24. The dispensing assembly of claim 23, wherein the movable closure member forms part of a dispensing adapter connected to the container around the outflow opening.

25. The dispensing assembly of claim 24, wherein the dispensing adapter includes an overflow conduit connected to the outflow opening of the container, and in that the closure member is arranged for closing off the outflow conduit.

26. The dispensing assembly of claim 25, wherein the outflow conduit has a curved outer edge, the closure member having a corresponding curvature and being pivotable about an axis.

27. The dispensing assembly of claim 26, wherein the closure member is arranged on the inside of the dispensing adapter and is connected to a control member on the outside of the dispensing adapter through the pivot axis.

28. The dispensing assembly of claim 27, wherein the closure member is more flexible than the surrounding structure of the dispensing adapter.

29. The dispensing assembly of claim 27, wherein the control member extends outside a profiled collar of the dispensing adapter.

30. The dispensing assembly of claim 24, wherein the dispensing adapter further includes a connector for interconnecting the source of displacing medium and the supply port.

31. Dispensing adapter for use in the dispensing assembly of claim 24.
